(19) United States
(12) Patent Application Publication
(10) Pub. No.: US 2011/0286451 A1
(43) Pub. Date: Nov. 24, 2011

(54) METHOD, APPARATUS AND COMPUTER PRODUCT FOR SENDING OR RECEIVING DATA OVER MULTIPLE NETWORKS

(75) Inventor: Ishai RABINOVITZ, Haifa (IL)

(73) Assignee: Mellanox Technologies Ltd., Yokneam (IL)

(21) Appl. No.: 12/785,499

(22) Filed: May 24, 2010

(51) Int. Cl. H04L 12/56

(52) U.S. Cl. 370/390

(57) ABSTRACT

A substantially transparent failover communication protocol comprises a sender sending data packets to one or more recipients. The sender and recipients may be connectable through two or more networks. The sender sends in some cases duplicate data packets, each addressed differently, such that a recipient may receive one copy. Both the recipients and the sender may perform predetermined actions in response to a network becoming unavailable, such that the data packets may still be received by the recipients.

### BACKGROUND

The present disclosure relates to communication protocols in general, and to communication protocols utilize multiple networks for relaying information, in particular.

Information is a valuable asset in modern life. Relaying information to another using communication techniques such as User Datagram Protocol (UDP), Transmission Control Protocol (TCP) or the like, may be desired. In some cases, a data packet comprising information is relayed to another. The data packet may be sent over a network such as the Internet, an intranet, a Local Area Network (LAN), a Wide Area Network (WAN) or the like.

In some cases, both the sender and the recipient of data packets are connected using several networks, such as for example two networks. In such a scenario at least one network is a redundant network, as the data packet may be sent to the recipient without utilizing the redundant network. The redundant network may be utilized to assure delivery of the data packet in case the non-redundant network becomes unavailable due to, for example, a failure in a connected hardware component, such as a communication switch or card, a failure in a physical link to the network, such as loss of signal of a wireless network or disconnection of a cable, failure of software associated with the network or the like.

In some cases, a failover mechanism may be employed to send the data packet in the redundant network in response to detection of unavailability of the non-redundant network.

### BRIEF SUMMARY OF THE INVENTION

One exemplary embodiment of the disclosed subject matter is a method for sending at least one data packet to a group of at least one computerized device, each computerized device is connectable with at least a first network and a second network, having a first address, a second address and a third address, the first address is associated with the group and the first network, the second address and the third address are associated with the group and the second network, the method comprising: selecting a method of sending a portion of the at least one data packet, the method of sending is selected between: a first method of sending comprises: sending the portion of the at least one data packet to the first address, over the first network; sending the portion of the at least one data packet to the third address, over the second network; and a second method of sending comprises: sending the portion of the at least one data packet to the second address, over the second network; and sending the portion of the at least one data packet by employing the method of sending.

In some exemplary embodiments, selecting is performed based on availability of the first network.

In some exemplary embodiments, the method further comprises having a computerized device of the group of the at least one computerized device registered to receive data packets to the first address, over the first network, and to the second address, over the second network; and receiving at the computerized device the at least one data packet once.

In some exemplary embodiments, upon detection that the first network is unavailable to the computerized device, registering the computerized device to receive data packets addressed to the second address and the third address in the second network.

In some exemplary embodiments, the first address, the second address and the third address are different multicast groups.

In some exemplary embodiments, sending the portion of the at least one data packet comprises unicasting the portion of the at least one data packet.

In some exemplary embodiments, sending the portion of the at least one data packet is performed by utilizing an unreliable communication protocol.

In some exemplary embodiments, the first network is a first subnet and the second network is a second subnet.

In some exemplary embodiments, the first network and the second network are separate networks.

In some exemplary embodiments, sending data packets is performed using an InfiniBand connector.

In some exemplary embodiments, the method further comprises determining the first address, the second address and the third address based on the group.

In some exemplary embodiments, the method further comprises having a fourth address associated with the group and the first network; and wherein the method of sending is selected between: the first method of sending; the second method of sending; and a third method of sending comprises: sending the portion of the at least one data packet to the second address, over the second network; and sending the portion of the at least one data packet to the fourth address, over the first network.

In some exemplary embodiments, selecting the method of sending is based upon a selection of a primary network, the primary network is selected from the at least the first network and the second network.

In some exemplary embodiments, selecting a method of sending a portion of the at least one data packet is performed more than once.

Another exemplary embodiment of the disclosed subject matter is a computerized system for sending at least one data packet to a group of at least one computerized device, each computerized device is connectable with at least a first network and a second network, the computerized system comprising: a network module connectable with at least the first network and the second network; a sending method selector configured to select a method of sending a portion of the at least one data packet, the method of sending is selected between: a first method of sending comprises: sending the portion of the at least one data packet to a first address associated with the group, over the first network; sending the portion of the at least one data packet to a third address associated with the group, over the second network; and a second method of sending comprises sending the portion of the at least one data packet to a second address so associated with the group, over the second network; and a sending module configured to send the portion of the at least one data packet based on the method of sending determined by the sending method selector.

In some exemplary embodiments, sending method selector comprises a network availability determinator

In some exemplary embodiments, sending method selector comprises a primary network determinator; and the method of sending is selected between: the first method of sending; the second method of sending; and a third method of sending comprises sending the portion of the at least one data packet to the second address, over the second network, and to a fourth address associated with the group, over the first network.

In some exemplary embodiments, sending method selector is configured to select the method of sending between: the first method of sending; the second method of sending; and a third method of sending comprises sending the portion of the at least one data packet to the first address, over the first network.

In some exemplary embodiments, the network module comprises an InfniBand connector.

In some exemplary embodiments, further comprising an address obtainer configured to obtain the first address, the second address and the third address.

In some exemplary embodiments, further comprise a computerized device of the group of at least one computerized device, the computerized device comprises: a receiving method selector, the method of receiving is selected between: a first method of receiving comprising receiving data packets sent to the first address, over the first network, and receiving data packets sent to the second address, over the second network; and a second method of receiving comprising receiving data packets sent to the second address, over the second network, and receiving data packets sent to the third address, over the second network; a receiver configured to receive data packets in the method of receiving selected by the receiving method selector.

In some exemplary embodiments, the receiving method selector comprises a second network availability determinator.

Yet another exemplary embodiment is a method for receiving at least one data packet by a computerized device, the data packets are sent to a group of at least one computerized device, the group comprising the computerized device, the computerized device is connectable with at least a first network, having a first address, the first address is associated with the group and the first network, and a second network, having a second address and a third address, the second address and the third address are associated with the group and the second network, the method comprising: registering the computerized device to receive data packets sent to the first address, over the first network; registering the computerized device to receive data packets sent to the second address over the second network; in response to a detection that the first network is unavailable to the computerized device, registering the computerized device to receive data packets sent to the third address over the second network; and receiving the at least one data packet once based on the registration of the computerized device.

In some exemplary embodiments, receiving the at least one data packet is performed using an InfiniBand connector; the method further comprises: determining the first address, the second address and the third address; determining a fourth address associated with the group and the first network; in response to a detection that the second network in unavailable to the computerized device, registering the computerized device to receive data packets sent to the fourth address, over the first network.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2 shows a flowchart diagram of a method for sending data packets, in accordance with some exemplary embodiments of the disclosed subject matter;

FIG. 3 shows a flowchart diagram of a method for receiving data packets, in accordance with some exemplary embodiments of the disclosed subject matter; and

FIG. 4 shows a block diagram of a sender and a recipient, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to enable a sender to send data packets without a need to determine a connection status of recipients.

Another technical problem dealt with by the disclosed subject matter is to enable a recipient to receive data packets without a need to determine a connection status of a sender.

Yet another technical problem dealt with by the disclosed subject matter is to enable a recipient to receive a data packet once, even in case the data packet is being transmitting redundantly.

Yet another technical problem dealt with by the disclosed subject matter is to provide a failover mechanism, enabling relaying of information between a sender and at least one recipient. The failover mechanism may enable a recipient to receive data packets sent by the sender as long as both the sender and recipient are connected to each other via at least one network.

Yet another technical problem dealt with by the disclosed subject matter is to provide a failover mechanism to a sender that does not need to inform recipients of its activation in order to function.

Yet another technical problem dealt with by the disclosed subject matter is to provide a failover mechanism to a recipient that does not need to inform a sender or recipients of its activation in order to function.

One technical solution is to utilize different communication channels by the sender to send duplicate data packets. The sender may send several copies of a data packet over at least two networks. A copy may be sent addressed to a primary address over one network. Other copies may be sent addressed to secondary addresses over other networks. A recipient may receive data packets addressed to primary addresses only, in case all networks are available.

In another technical solution provided by the disclosed subject matter, a failover mechanism of the recipient may enable receiving data packets addressed to secondary address in case one network is not available to the recipient.

Yet another technical solution may utilize different types of networks to provide for the different communication channels, such as for example one channel utilizing an InfiniBand-based netword and another channel utilizing a non-InfiniBand-based network, such as for example an Ethernet network or the like.

One technical effect of utilizing the disclosed subject matter is receiving each data packets once by each recipient. Receiving each data packet once, even though it may be sent twice over different communication channels may enable a relatively efficient communication protocol, as duplicate identification process, which may be inefficient or may require a relatively substantial amount of time, may not be required.

Another technical effect of utilizing the disclosed subject matter is to enable relay of data packets under various connection schemas. In an environment comprising a first and second networks, several entities may communicate in accordance with the disclosed subject matter. Consider the following connection schema: the first sender is connected to the first network, the second sender is connected to both networks, the first recipient is connected to the first network and the second recipient is connected to both networks. In the aforementioned connection schema or a similar schema the disclosed subject matter may enable relaying of data packets from the first sender to both the first and second recipients, and from the second sender to the first and second recipients.

Yet another technical effect of utilizing the disclosed subject matter is to enable the sender and recipient to be unaware of a connection status of one another, and avoid a need of synchronizing upon usage of failover mechanism.

The disclosed subject matter is explained in respect to a single group of recipients. However, the disclosed subject matter may utilized in respect to multiple groups of recipients. Each group may be handled independently in accordance with the disclosed subject matter. In some exemplary embodiments, a recipient may be a member of several groups.

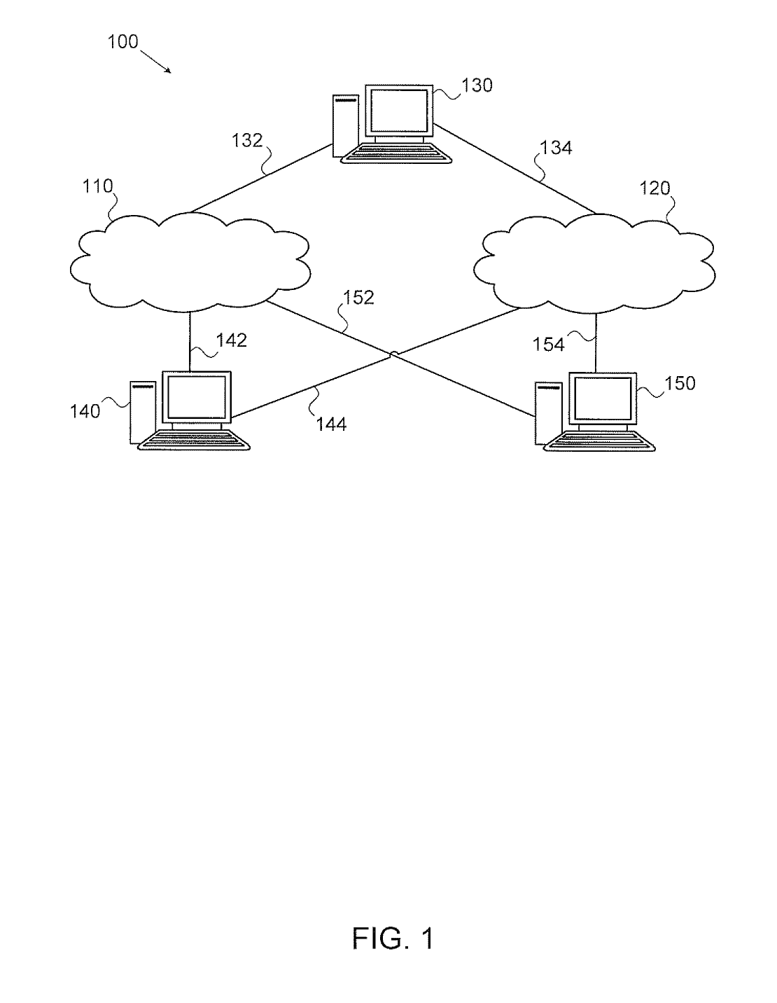

Referring now to FIG. 1 showing a computerized environment in which the disclosed subject matter is used, in accordance with some exemplary embodiments of the subject matter. A computerized environment 100 may comprise a first network 110 and a second network 120. The networks 110, 120 may be separate networks, such as different LANs. The networks 110, 120 may be connected, such as for example being two LANs connected in a single WAN. The networks 110, 120 may be different subnets, such as for example each network may be associated with a different set of addresses.

It will be noted that the disclosed subject matter is not limited to using two networks. Additional networks may be further utilized and provide for a better stability of the computerized environment 100. However, for simplicity of explanation only, the present disclosure details a use of two networks 110 and 120. The notion of using additional networks may be implemented by a person of skill in the art based on the disclosure provided. One exemplary embodiment may be an inductive extension of the exemplary embodiment that utilizes two networks, such that a network may comprise two “sub-networks”. Another exemplary embodiment may utilize a predetermined order between the networks, such as that a primary, secondary and ternary addresses may be utilized. Other embodiments may utilize the disclosed subject matter in different manners.

The computerized environment 100 may further comprise computerized devices 130, 140, 150. The computerized devices 130, 140, 150 may be connectable to networks 110 and 120. The computerized device 130 may be connectable to the first network 110 via a first link 132 and to the second network 120 via a second link 134. Computerized devices 140, 150 may be connectable similarly to the networks 110 and 120 via links 142, 144, 152 and 154. A link, such as for example the link 132, may be a wired connection, a wireless connection or any other link enabling communication from a computerized device to a network. The computerized devices 130, 140, 150 may be any computerized device, such as Personal Computers (PC), laptop computers, storage servers, computerized server, mobile devices, Personal Digital Assistants (PDA) and the like. In some exemplary embodiments, a network, such as 110, may have a different availability status in respect to a first computerized device than that of a second computerized device. For example, a hardware failure in the first computerized device may render the network 110 unavailable to the first computerized device, whereas the network 110 may be available to the second computerized device. In some exemplary embodiments, a computerized device, such as 130, may have a first network, such as 110, available to the computerized device and a second network, such as 120, unavailable to the computerized device. The network availability may change over time in respect to a computerized device, such as 130. The network availability may change from being available to being unavailable and vice-versa.

In some exemplary embodiments, the computerized device 130 may send data packets to the computerized devices 140 and 150. In some exemplary embodiment, a recipient, such as the computerized device 140, may send data packets to the sender, such as the computerized device 130. In some exemplary embodiments, several computerized devices may send data. In some exemplary embodiments, a sender may send data packets to a single recipient. In some exemplary embodiments, a sender may multicast data packets to a group of recipients, such as the computerized devices 140 and 150. In some exemplary embodiments, a sender may unicast data packets to a single recipient, such as the computerized device 140.

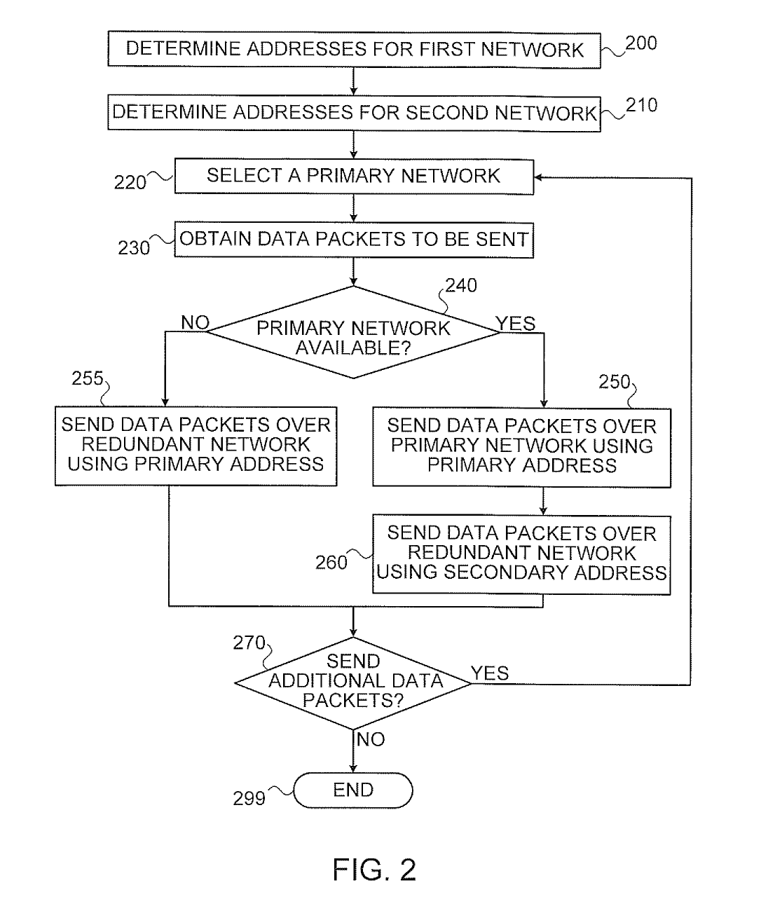

Referring now to FIG. 2 showing a flowchart diagram of a method for sending data packets, in accordance with some exemplary embodiments of the disclosed subject matter. The method of FIG. 2 may be performed by a computerized device, such as 130 of FIG. 1.

In steps 200 and 210, addresses in a first network and a second network may be determined. The addresses may be associated with a group of one or more devices to which data packets are sent. For example, an address may be a multicast address. In some exemplary embodiment, the group may be represented by a group identifier. The group identifier may be utilized to determine the address.

In some exemplary embodiments, for each network a primary address and a secondary address are determined in respect to the group. The addresses may be determined by an address obtainer. In other exemplary embodiments, a primary address may be determined in respect to a predetermined network, such as 110 of FIG. 1, and a primary address and a secondary address may be determined in respect to each additional network, such as 120 of FIG. 1.

In some exemplary embodiment, a primary address may differ from a secondary address by a predetermined bit, such as for example a Least Significant Bit (LSB), or otherwise differ from one another by predetermined characteristics. In some exemplary embodiments, the group identifier is an address, such as for example an IP address, a multicast address or the like. The address may be modified by a predetermined operation, such as by setting a value of a predetermined bit to zero, to provide a secondary address. The address may be modified by another predetermined operation, such as by setting a value of the predetermined bit to one, to provide a primary address. In one exemplary embodiment, the group identifier may be received from a communication layer instructing to send data packets to a group identified by an address. The secondary and primary addresses may be determined by manipulating the address using predetermined manipulations.

It will be noted that primary and secondary addresses may be any addresses. The addresses are referred to as “primary” or “secondary” for explanation purposes only. As long as the participants in a communication protocol in accordance with the disclosed subject matter are coordinated on which address is utilized for each purpose, the addresses may be replaced or even interchanged. It will be further noted that in some exemplary embodiments, an address may be unique in respect to a network, such as a subnet. In such exemplary embodiments, a same primary address associated with the group may be determined in respect to the first network and the second network.

In step 220, a primary network, also referred to as non-redundant network, may be selected. The network is referred to as primary or non-redundant for explanation purposes only. Each network may be selected as the primary network.

In step 230, data packets to be sent may be obtained. For example, the data packets may be obtained from a communication layer. The data packets may be obtained from an application of the computerized device performing the disclosed method. The disclosed subject matter is not limited to obtaining the data packets from one source or another. In some exemplary embodiments, a predetermined network, such as network 110 of FIG. 1, is defined as a primary network, and all participating parties (senders and recipients) are informed of this definition. In other exemplary embodiments, each sender may select a different primary network.

In step 240, a determination whether the primary network is available may be performed. A sender may determine that a network is unavailable based on a connection between the sender to the network. In some exemplary embodiments, a connection may be lost due to various reasons such as for example failure of a network adapter or other hardware component, failure of a driver or other software component, disconnection of a physical link to the network and the like. In response to a determination that the primary is network is available, step 250 may be performed. In response to a determination that the primary network is unavailable, step 255 may be performed.

In step 250, the data packets obtained in step 230 may be sent over the primary network. The data packets may be sent to the primary address associated with the primary network, such as for example by addressing the data packets to the primary address. In some exemplary embodiments, recipients listen on each primary address associated with a network the recipients are connected to. By sending the data packets addressed to primary networks, each recipient connected to the primary network is enabled to receive the data packets.

In step 260, the data packets obtained in step 230 may be sent over a redundant network (i.e., not the primary network). The data packets may be sent using the secondary address. By sending an additional copy of the data packets using the redundant network a recipient not connected to the primary network is able to receive the data packets. By sending the additional copy addressed to the secondary address and not to a primary address, recipients that are connected to the primary network may avoid receiving the data packets twice.

In step 255, the data packets may be sent over the redundant network and addressed to the primary address. By sending the data packets over the redundant network using the primary address, a recipient that is connected to the redundant network may be enabled to receive the data packets by listening on the primary address.

It will be noted that in some exemplary embodiments, a recipient may be unaware of whether the primary network is available to the sender. The recipient may be unaware of the selection of the primary network. The recipient may be connected to both networks and still be able to receive the data packets once in both cases (i.e., a first case of performing steps 250 and 260 or a second case of performing step 255). For example, the recipient may receive the data packet once in both cases by listening on both networks only on primary addresses. In case the recipient is connected to a single network, the recipient may still be able to receive the data packets once by, for example, listening on both the secondary and primary addresses. It will be noted that in an exemplary embodiment in which the recipient is aware that the available network is the predetermined primary network, the recipient may listen to the primary address only and still be assured delivery of the data packets.

It will be further noted that listening on an address is a relatively simple operation that requires a reasonably low amounts of resources. In addition, listening on an address that is not ordinarily used (such as a secondary address of the primary network) is possible and has substantially no effect one way or the other.

In case an additional data packets are required to be sent, as determined in step 270, step 220 may be performed again. It will be noted that in some exemplary embodiments, in each iteration of steps 220 through 270, a different primary network may be selected. In some exemplary embodiments, the availability of the primary network, determined in step 240, may be different in each iteration. It will be further noted that in case both the first and second networks are unavailable, sending a data packets may be impossible until one of the networks becomes available.

In case additional data packets are not deemed to be sent, step 299 may be performed, and the method of FIG. 2 may end.

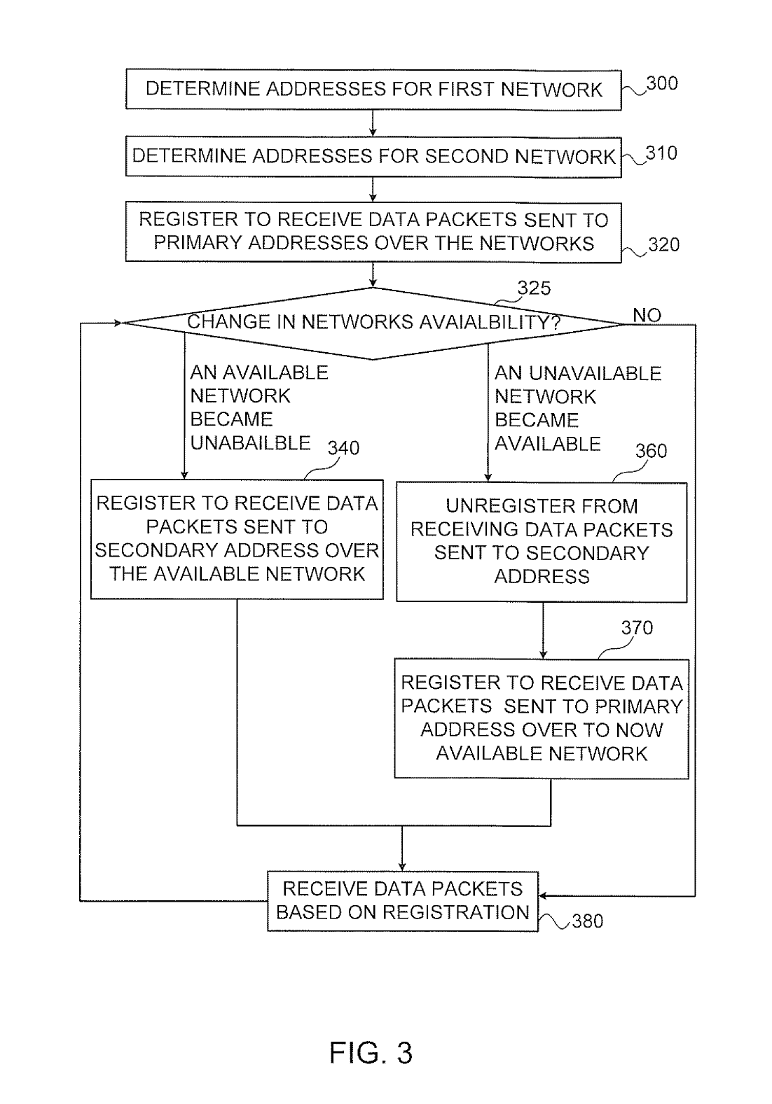

Referring now to FIG. 3 showing a flowchart diagram of a method for receiving data packets, in accordance with some exemplary embodiments of the disclosed subject matter. The method of FIG. 3 may be performed by a computerized device, such as 130 of FIG. 1.

In steps 300 and 310 addresses associated with a first and second network may be determined, obtained or the like. Steps 300 and 310 may be similar to steps 200 and 210 of FIG. 2. In some exemplary embodiments, a primary address determined in step 200 is also determined as a primary address in step 300. In some exemplary embodiments, a primary address determined in step 200 is also determined as a primary address in step 310. The same may apply to secondary addresses. In case of a predetermined primary network, the step associated with determining addresses to the primary network, may determine a primary address only.

In step 320, registration may be performed such that the recipient may receive data packets addresses to primary addresses over the networks. In case both networks are available to the recipient, the recipient may listen for data packets sent to primary addresses.

In some exemplary embodiments, as the sender may send data packets to primary addresses on either steps 250 or 255 of FIG. 2, which are alternative steps, the recipient may receive, based on the registration in step 320, each data packet once. The network that may be utilized to receive the data packet may differ, depending on availability of networks to the sender or on the determination of a primary network by the sender.

Steps 325 to 380 may be performed to ensure receipt of data packets even in case availability of networks changes. In some cases, an event-driven process may be utilized in lieu of a busy-loop process depicted in steps 325 to 380.

In step 325, a determination may be made whether there is a change in the availability of any of the networks. In case an available network becomes unavailable, step 340 may be performed before step 380. In case an unavailable network becomes available steps 360 and 370 may be performed before step 380. In case no change in availability is determined before receipt of an additional data packet, step 380 may be performed.

A network may be determined to be unavailable in case it does not enable delivery of data sent by the sender. The determination may be similar to that performed by step 240 of FIG. 2.

In step 340, the recipient may register to receive data packets sent to a secondary address over the available network. For example, in ease a first network is unavailable, the recipient may register to receive data packets sent to the secondary address over the second network. In some exemplary embodiments, in case the available network is the predetermined primary network, there may not be any data packet that is sent to a secondary address over the primary network. Performing step 340 may be avoided in such a case. However, performing step 340 in such a case is still applicable, although it may not have any affect.

In some exemplary embodiments, the sender may send data packets over the available network either addressed to primary address (e.g., steps 250 or 255 of FIG. 2) or addresses to a secondary address (e.g., step 260 of FIG. 2). Therefore, the recipient may receive the data packet, since the recipient may be registered to receive data packets sent to the primary addresses over the available network (e.g., step 320). In case the sender is connected to both networks, and the primary network selected by the sender (e.g., in step 220 of FIG. 2) is unavailable to the recipient, the sender may send the data packets also addressed to secondary address over the available network (e.g., step 260 of FIG. 2). Therefore, based on the registration in step 340, the recipient may receive the data packet. In some exemplary embodiments, the recipient may receive the data packet once, regardless of the scenario (as long as a valid connection between the sender and recipient is available).

In case an unavailable network becomes available steps 360 and 370 may be performed. In step 360, the recipient may unregister from the secondary address to which the recipient registered in a corresponding step 340. In step 370, the recipient may register to receive data packets sent to the primary address of the now available network. In some exemplary embodiments, registration in step 370 may be omitted as the registration of step 320 may take affect when the network becomes available.

In other exemplary embodiments, step 370 may be performed before step 360 to avoid dropping a data packet sent to the secondary address from which the recipient is unregistering.

In some exemplary embodiments, in order to coupe with a possible race between steps 360 and 370, in which data packets may be lost or received as duplicates, the step 360 may be performed in response to a grace period elapsing. During the grace period, which may last, for example, a few seconds, duplicative data packets may be received by the recipient (e.g., in step 380). The recipient may deduplicate data packets during the grace period. The grace period may be utilized to provide a higher likelihood that no data packet is lost. The grace period may be a timeframe associated with a time that takes a sent data packet to be received. One exemplary grace period may be three times the aforementioned time. Another exemplary grace period may be twice a round-trip delay time.

In step 380, data packets may be received based on registrations made in either steps 320, 340, 360 or 370. Based on the disclosed subject matter, and as long as the sender sends data packets in accordance with the disclosed subject matter, the recipient may receive each sent data packet. The recipient may further receive each sent data packet once, even in case the sender sent several copies of the data packet.

Step 325 may be performed again, as long as the recipient may require, determine, need or desire to stay in a listening mode and receive additional data. For example, in some communication protocols, the recipient may determine that additional data packets are destined to be sent and may require receiving them. In other communication protocols, a daemon process may maintain “listening mode” as long as the daemon process is operating. In other exemplary embodiments, a process may determine an amount of data packets to receive; once the amount is received, the process may end its “listening mode”. In some exemplary embodiments, a sender may send an “end-of-transmission” packet or otherwise indicate the end of the transmission.

It will be noted that registration made in the method of FIG. 3, such as for example, in step 320, may, in some cases, be performed by an entity other than the recipient. For example, an administrator process may register the recipients to receive the data packets sent to primary addresses. The administrator process may, in some exemplary embodiments, determine the network availability of a recipient and modify its registration accordingly. In other exemplary embodiment, the recipient may perform the aforementioned registrations. In some exemplary embodiments, a combination of the above may be performed.

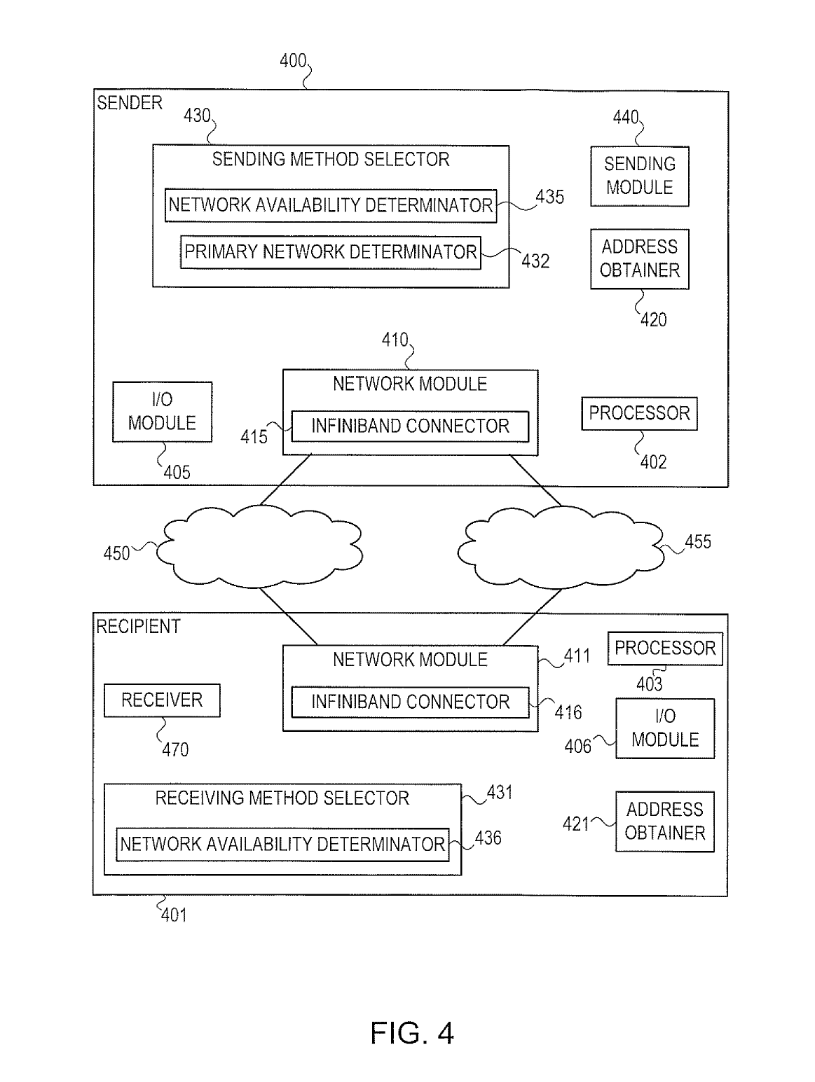

Referring now to FIG. 4 showing a block diagram of a sender and a recipient, in accordance with some exemplary embodiments of the disclosed subject matter. A sender 400 may be a computerized device such as 130 of FIG. 1. A recipient 401 may be a computerized device, such as 130 of FIG. 1. A computerized device may be both a sender 400 and a recipient 401 and comprise both the components of 400 and 401. In some exemplary embodiments, a computerized device may be a recipient, a sender or a combination thereof, depending on the ability of the computerized device to receive and send data packets in accordance with the disclosed subject matter.

In some exemplary embodiments of the disclosed subject matter, the sender 400 may comprise an Input/Output (I/O) module 405, as is known in the art. In some exemplary embodiments, the receiver 401 may comprise an I/O module 406, as is known in the art.

In some exemplary embodiments, the sender 400 may comprise a processor 402. The processor 402 may be a Central Processing Unit (CPU), a microprocessor, an electronic circuit, an Integrated Circuit (IC) or the like. The processor 402 may be utilized to perform computations required by the sender 400 or any of its subcomponents. In some exemplary embodiments, the recipient 401 may comprise a processor 403, similar to the processor 402.

In some exemplary embodiments, the sender 400 may comprise a network module 410. The network module 410 may enable the sender 400 to connect to at least two networks 450, 455, such as networks 110, 120 of FIG. 1. In some exemplary embodiments, the network module 410 may comprise an InfiniBand connector 415 connectable with the networks 450 and 455, such as for example using different ports. In other exemplary embodiments, the network module 410 may comprise several components, such as the InfiniBand connector 415, each component connectable with a different network. In some exemplary embodiments, different components may utilize different communication protocols such as InfiniBand, Internet Protocol, Ethernet or the like.

In some exemplary embodiments, the recipient 401 may comprise a network module 411 similar to the network module 410. The network module 411 may comprise an InfiniBand connector 416, similar to the InfiniBand connector 415.

In some exemplary embodiments, the sender 400 may comprise a sending method selector 430. The sending method selector 430 may select a sending method in accordance with the disclosed subject matter. The sending method selector 430 may select a sending method between various sending methods, such as for example the following sending methods: sending two copies, one over a primary network using a primary address and one over a redundant network using a secondary address; sending one copy over one network using a primary address; or the like. Other sending methods in accordance with the disclosed subject matter may be selected.

In some exemplary embodiments, the sending method selector 430 may comprise a network availability determinator 435 configured to determine availability of a network, such as 450. In some exemplary embodiments, the network availability determinator 435 may determine network availability performed in step 240 of FIG. 2. The network availability determinator 435 may utilize the network module 410 to determine availability of the network. The sending method selector 430 may utilize the network availability determinator 435 to select a method of sending.

In some exemplary embodiments, the sending method selector 430 may comprise a primary network determinator 432. The primary network determinator 432 may determine a primary network out of the networks 450 and 455. The primary network determinator 432 may select a primary network based on predetermined parameters, rules or the like. For example, there may be a preference to select a network that has fewer failures, is more frequently available, is associated with a higher bandwidth, or the like. In some exemplary embodiments, the primary network determinator 432 may determine the primary network based on a random decision or other non-deterministic behavior. The primary network determinator 432 may select a different primary network in different times. In some exemplary embodiments, the primary network determinator 432 may select the primary network based on a predetermined determination of the primary network. In some exemplary embodiments, the primary network determinator 432 may perform the determination of step 240 of FIG. 2.

In some exemplary embodiments, the sender 400 may comprise a sending module 440. The sending module 440 may be configured to send data packets by the sending method determined by the sending method selector 430. The sending module 440 may utilize the network module 410 to send data packets. In some cases, the sending module 440 may be configured to create duplicate copies of a data packet and send the duplicates over different networks. In some exemplary embodiments, the sending module 440 may perform sending operations of FIG. 2, such as 250, 255, 260 or the like. The sending module 440 may further determine the determination of step 270 of FIG. 2.

In some exemplary embodiments, the sender 400 may comprise an address obtainer 420. The address obtainer 420 may be configured to obtain addresses, such as 3D primary addresses, secondary addresses or the like. The addresses may be obtained in respect to a group of recipients. The addresses may be determined based on a predetermined function between group identifiers and addresses. In some exemplary embodiments, the address obtainer 420 may perform the determination of step 200 and 210 of FIG. 2.

In some exemplary embodiments, the recipient 401 may comprise an address obtainer 421 similar to the address obtainer 420. In some exemplary embodiments, the address obtainer 421 may perform the steps 300 and 310 of FIG. 3.

In some exemplary embodiments, the recipient 401 may comprise a receiving method selector 431. The receiving method selector 431 may be configured to select a method of receiving data packets in accordance with the disclosed subject matter. The receiving method selector 431 may comprise a network availability determinator 436 similar to the network availability determinator 435. The receiving method selector 431 may utilize the network availability determinator 436 to select a method of receiving. The method of receiving may be selected between various receiving methods such as for example: receiving data packets sent over different networks and addressed to primary addresses; receiving data packets sent over a single network and addressed to primary and secondary addresses; receiving data packets sent over a primary network and addressed to primary address; or the like. Other methods of receiving in accordance with the disclosed subject matter may be selected.

In some exemplary embodiments, the receiving method selector 431 may comprise and utilize a primary network determinator (not shown) similar to the primary network determinator 432 comprised by the sender 400.

In some exemplary embodiments, the recipient 401 may comprise a receiver 470 configured to receive data packets. The receiver 470 may utilize the network module 411 to receive data packets. The receiver 470 may register or unregister the recipient 401 from receiving a data packet based on an address to which the data packet is addressed and/or based on a network via which the data packet is being sent. The receiver 470 may receive the data packets in accordance with a selection of the receiving method selector 431. In some exemplary embodiments, the receiver 470 may perform some steps of FIG. 3 such as for example steps 320, 340, 360, 370 or 380.

In some exemplary embodiments, the sender 400 or the recipient 401 may employ an InfiniBand switch to communicate over at least one network. In InfiniBand-based networks a subnet may be maintained by a component known as a subnet manager. As the subnet manager may intermittently fail, a backup manager may be utilized. However, failover between subnet managers may be cause a delay. In some cases, it may be beneficial to utilize two different InfiniBand networks each being managed by a different subnet manager. In an exemplary embodiment of the disclosed subject matter, relatively quick failover is available in case of a subnet manager has failed, as the sender and receiver utilize the subnet that did not fail in order to send and receive data packets.

The disclosed subject matter may be utilized in a computerized environment comprising a sender connected to multiple networks and a plurality of recipients, each connected to a subset of the multiple networks. Some or all of the subset may differ from one another. For example, the sender may be connected to three networks denoted as “A”, “B” and “C”. Various recipients may be connected to different subsets such as “A” and “B” and “C”; “A” and “B”; “A” and “C”; “B”; or the like. The disclosed subject matter may be utilized to send data by the sender to the plurality of recipients without having the sender determine a specific network to utilize to contact each recipient.

The flowchart and block diagrams in the Figures illustrate the architecture, functionality, and operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosed subject matter may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosed subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or is entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method for sending at least one data packet to a group of at least one computerized device, each computerized device is connectable with at least a first network and a second network, having a first address, a second address and a third address, the first address is associated with the group and the first network, the second address and the third address are associated with the group and the second network, said method comprising:
selecting a method of sending a portion of the at least one data packet, the method of sending is selected between:
a first method of sending comprises:
sending the portion of the at least one data packet to the first address, over the first network;
sending the portion of the at least one data packet to the third address, over the second network; and
a second method of sending comprises:
sending the portion of the at least one data packet to the second address, over the second network; and
sending the portion of the at least one data packet by employing the method of sending.

2. The method of claim 1, wherein said selecting is performed based on availability of the first network.

3. The method of claim 1, further comprising:
having a computerized device of the group of the at least one computerized device registered to receive data packets to the first address, over the first network, and to the second address, over the second network; and
receiving at the computerized device the at least one data packet once.

4. The method of claim 3, further comprising:
upon detection that the first network is unavailable to the computerized device, registering the computerized device to receive data packets addressed to the second address and the third address in the second network.

5. The method of claim 1, wherein the first address, the second address and the third address are different multicast groups.

6. The method of claim 1, wherein said sending the portion of the at least one data packet comprises unicasting the portion of the at least one data packet.

7. The method of claim 1, wherein said sending the portion of the at least one data packet is performed by utilizing an unreliable communication protocol.

8. The method of claim 1, wherein the first network is a first subnet and the second network is a second subnet.

9. The method of claim 1, wherein the first network and the second network are separate networks.

10. The method of claim 1, wherein sending data packets is performed using an la InfiniBand connector.

11. The method of claim 1 further comprises determining the first address, the second address and the third address based on the group.

12. The method of claim 1, further comprises having a fourth address associated with the group and the first network; and
wherein the method of sending is selected between:
the first method of sending;
the second method of sending; and
a third method of sending comprises:
sending the portion of the at least one data packet to the second address, over the second network; and
sending the portion of the at least one data packet to the fourth address, over the first network.

13. The method of claim 12, wherein said selecting the method of sending is based upon a selection of a primary network, the primary network is selected from the at least the first network and the second network.

14. The method of claim 1, wherein said selecting a method of sending a portion of the at least one data packet is performed more than once.

15. A computerized system for sending at least one data packet to a group of at least one computerized device, each computerized device is connectable with at least a first network and a second network, said computerized system comprising:
a network module connectable with at least the first network and the second network;
a sending method selector configured to select a method of sending a portion of the at least one data packet, the method of sending is selected between:
a first method of sending comprises:
sending the portion of the at least one data packet to a first address associated with the group, over the first network;
sending the portion of the at least one data packet to a third address associated with the group, over the second network; and
a second method of sending comprises sending the portion of the at least one data packet to a second address associated with the group, over the second network; and
a sending module configured to send the portion of the at least one data packet based on the method of sending determined by said sending method selector.

16. The computerized system of claim 15, wherein said sending method selector comprises a network availability determinator.

17. The computerized system of claim 15, wherein:
said sending method selector comprises a primary network determinator;
the method of sending is selected between:
the first method of sending;
the second method of sending; and
a third method of sending comprises sending the portion of the at least one data packet to the second address, over the second network, and to a fourth address associated with the group, over the first network.

18. The computerized system of claim 15, wherein said sending method selector is configured to select the method of sending between:
the first method of sending;
the second method of sending; and
a third method of sending comprises sending the portion of the at least one data packet to the first address, over the first network.

19. The computerized system of claim 15, wherein said network module comprises an InfiniBand connector.

20. The computerized system of claim 15 further comprising an address obtainer configured to obtain the first address, the second address and the third address.

21. The computerized system of claim 15 further comprising a computerized device of the group of at least one computerized device, said computerized device comprises:
a receiving method selector, the method of receiving is selected between:
a first method of receiving comprising receiving data packets sent to the first address, over the first network, and receiving data packets sent to the second address, over the second network; and
a second method of receiving comprising receiving data packets sent to the second address, over the second network, and receiving data packets sent to the third address, over the second network; and
a receiver configured to receive data packets in the method of receiving selected by said receiving method selector.

22. The computerized system of claim 21, wherein said receiving method selector comprises a second network availability determinator.

23. A method for receiving at least one data packet by a computerized device, the data packets are sent to a group of at least one computerized device, the group comprising the computerized device, the computerized device is connectable with at least a first network, having a first address, the first address is associated with the group and the first network, and a second network, having a second address and a third address, the second address and the third address are associated with the group and the second network, said method comprising:
registering the computerized device to receive data packets sent to the first address, over the first network;
registering the computerized device to receive data packets sent to the second address over the second network;
in response to a detection that the first network is unavailable to the computerized device, registering the computerized device to receive data packets sent to the third address over the second network; and
receiving the at least one data packet once based on the registration of the computerized device.

24. The method of claim 23, wherein said receiving the at least one data packet is performed using an InfiniBand connector; the method further comprises:
determining the first address, the second address and the third address;
determining a fourth address associated with the group and the first network; and
in response to a detection that the second network in unavailable to the computerized device, registering the computerized device to receive data packets sent to the fourth address, over the first network.
